(19) United States
(12) Patent Application Publication
(10) Pub. No.: US 2022/0026779 A1
(43) Pub. Date: Jan. 27, 2022

(54) ROBOTIC OPTICAL SWITCHING SYSTEM

(71) Applicant: EPCOMM INC, San Francisco, CA (US)

(72) Inventor: Xuezhe Zheng, San Diego, CA (US)

(21) Appl. No.: 16/936,404

(22) Filed: Jul. 22, 2020

(51) Int. Cl. G02F 1/31; H02K 37/10; B25J 9/12; B25J 5/02; B25J 9/04; B25J 15/00; H04Q 11/00

(52) U.S. Cl. CPC G02F 1/31; H02K 37/10; B25J 9/126; B25J 5/02; H04Q 2011/0052; B25J 15/00; H04Q 11/0005; G02F 2201/02; B25J 9/041

(57) ABSTRACT

A robotic fiber switching system switching between two sets of patch cords is disclosed. The connectors for inner patch cords are placed on multiple layers of stackable rotors which moves into the targeted port by utilizing the interaction of magnetically activated coils and nearby magnets. Multiple layers of stackable stator base are placed outside of the stackable rotors, around which the outer patch cords are placed. To establish a connection, a robot sliding on a rail surrounding the stackable stator is configured to move to the targeted port on the rail, using a robotic arm to pull the corresponding outer patch cord connector from a parking stand and latch it into the adaptor of the inner patch cord at the targeted port.

### CROSS-REFERENCE TO RELATED APPLICATION AND CLAIM OF PRIORITY

The present disclosure claims priority under 35 U.S.C. § 119(e) to U.S. Provisional Patent Application Ser. No. 62/822,302, filed on Mar. 22, 2019, entitled Robotic Fiber Cross-Connect System.

### TECHNICAL FIELD

This disclosure relates to an optical fiber cross-connect system. Specifically, this disclosure relates to an optical fiber circuit switching system with latching using stacked rotor plates and a moving robot for optical fiber cross-connect.

### BACKGROUND OF THE INVENTION

The world is more and more connected with optical fibers. IT networking innovations have been mostly applied to layers 0 to 6 of the communication networks while the physical interconnects layer remains unchanged for decades. As the IT infrastructure scales to meet the ever-growing application and service demands, the scale of the physical connectivity layer in data centers, telecom central offices and wireless networks is quickly becoming a huge challenge for manual service and management. An emerging need is a “smart” physical connectivity layer which can help IT services with software defined networking to better utilize the resources and achieve lower cost.

### SUMMARY OF THE INVENTION

The present disclosure describes a robotic fiber switching system. The system uses a sliding robot to insert fiber connectors into adaptors mimicking manual latching-on operations. One of the advantages of the system is in that it uses off-the-counter connectors and adaptors that keep the cost low. By using stackable and modular parts, the system can be easily scaled up or scaled back according to the needs of specific projects. The system also provides a design that allows one side of the patch cords, i.e. the outer patch cords in the disclosure, to be fixedly placed in the system hence reducing the cord entanglement.

According to an embodiment of the present disclosure, the system includes n layers of stacked stators. each stator has m slots among m stator posts, providing n×m ports. The system further includes n layers of stacked rotors configured to turn inside of the stacked stators, each layer corresponding to a layer of the stacked stators and including a first connector. The system further includes m second connectors disposed of outside of the stacked stators, each corresponding to a slot of the stator. The system further includes a robotic head configured to move on a rail surrounding the n stacked stators, wherein a robotic arm located on a top of the robotic head is configured to connect the first connector and the second connector at a port of the robotic fiber switching system and wherein m and n are natural numbers.

According to another embodiment of the present disclosure, a method of a robotic fiber switching system is disclosed. The method includes the steps of determining to establish a connection between an i^{th} first connector of n first connectors to a P second connector of m second connectors, wherein each of the n first connectors is disposed of on a corresponding layer of stacked rotors and each of the m second connectors are disposed of in a corresponding slot outside of n layers of stacked stators; turning a stacked rotor in the i^{th} layer to the j^{th} slot of the stacked stator; moving a robotic head on a rail to the j slot; and connecting the j^{th} second connector to the i^{th} first connector.

According to yet another embodiment of the present disclosure a fiber switching system is disclosed. The system includes n layers of stackable rotors, each stackable rotor comprising a first connector connected with a first patch cord; n layers of stackable stator, each stackable stator comprising: a second connector connected to a second patch cord; and m slots; and a robotic arm configured to access the m slots by moving on a rail horizontally and to the n layers vertically, wherein the robotic arm latches the second connector to the first connector via an adaptor to establish connection between the first patch cords and the second patch cords.

Additional features and advantages will be set forth in the detailed description that follows, and in part will be readily apparent to people skilled in the art from the description or recognized by practicing the condiments as described in the written description and claims hereof, as well as the accompanying drawings.

It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The above-mentioned advantages and other features of the present invention will become more apparent to and the invention will be better understood by people skilled in the art with reference to the following description of the preferred embodiments of the invention taken in conjunction with the accompanying drawings, wherein:

FIG. 1 is a prior art robotic fiber cross-connect system;

FIG. 2 illustrates a robotic fiber switching system according to an embodiment of the present disclosure;

FIG. illustrates a stackable rotor according to an embodiment according to an embodiment of the present disclosure;

FIG. illustrates a stackable stator according to an embodiment of the present disclosure;

FIG. 5. illustrates the stepping mechanism of the stackable stator in the fiber patching system according to an embodiment of the present disclosure.

### DETAILED DESCRIPTION OF THE PREFERRED EMBODIMENTS

Several embodiments of the present disclosure are illustrated by the accompanying drawings and described in detail below. In the figures of the accompanying drawings, elements having the same reference numeral designations represent like elements throughout. The drawings are not to scale, unless otherwise noted. The embodiments are described by way of example, and not by limitation. All terminologies and phraseology used herein are for the purpose of illustrating only and should not be understood as limiting. The phrases such as “including”, “comprising”, “having” and other variations thereof are meant to encompass the items as described and their equivalents without excluding any additional items thereof.

Those skilled in the art will understand that the principles of the present disclosure may be implemented with a number of suitably arranged systems and devices that may vary from the embodiments but are within the scope of the present disclosure.

Optical fiber cross-connect systems, e.g. systems connecting two different termination locations using physical and hardwired cable within a datacenter, is the key element to realize a “smart” physical connectivity layer. Over the past couple of decades, various optical switches have been developed for automated fiber cross-connect. But few meets the performance requirements of all the applications in terms of optical loss, switching time and port count. For active networking, circuit switching time in milliseconds and below is a must. The optical loss is also preferred to be less than 3 dB as the standard transceivers are typically made for a link loss budget not considering the additional loss from the insertion of a fiber cross-connect element. 3D MEMS and collimator steering switching technologies are more suitable as they have reasonably fast switching on the order of a few 10s of milliseconds, and reasonably low loss on the order of 2-3 dB. See X. Zheng et al., “Three-Dimensional MEMS Photonic Cross-Connect,” IEEE J. Sel. Top. Quantum Electron., vol. 9, no. 2, pp. 571-578, 2003; See also Hagood et al, “Beam-steering optical switching apparatus,” U.S. Pat. No. 7,095,916 B2, 2006.

However, for applications such as automated fiber patch panel or optical distribution frame (ODF), the switching time is not very critical as the fiber patching is traditionally done manually. But the optical loss of each connection has to be very low, with less than 1 dB preferred. In addition, latching is typically required for this type of applications once a fiber connection is made to guarantee reliable physical connection against power outage, earthquake, etc.

For low cost, low loss fiber switching with latching, robotic fiber switching is an excellent solution. A few robotic fiber switches have been provided and commercialized previously. (See Wave2wave Solution, ROME 500. http://www.wave-2-wave.com/rome-500.html; Mizukami et al., “200×200 automated optical fiber cross-connect equipment using a fiber-handling robot for optical cabling systems,” in OFC/NFOEC 2005-2005 Conference on Optical Fiber Communication/National Fiber Optic Engineers Conference, 2005, p. OFP5; “Telescent G3 NTM.” [Online]. Available: http://www.telescent.com/products/.)

For example, in Wave2wave Solution, supra, two robots connect a pair of LC ferrule based custom optical connectors over a mechanical matrix structure. With the connectors clamped onto the matrix, the connection is latched. The customized connector design has the benefit of achieving reasonably large port count in a compact design. A switch with 256×256 duplex ports is realized fitting in a 19″ rack. But customized fiber connector design also resulted in high cost such as a cost of more than $100 per fiber port.

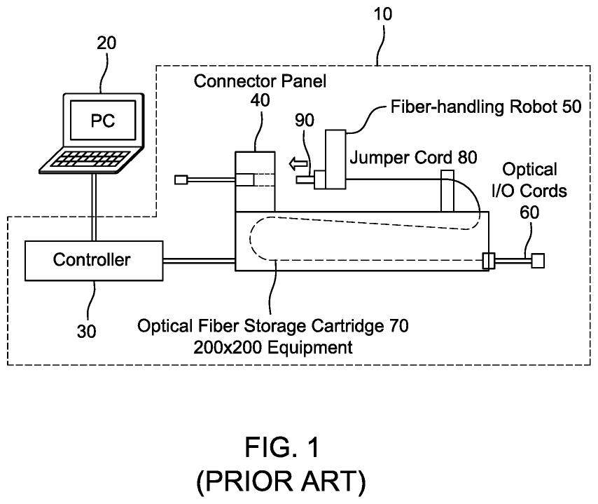

Low cost robotic fiber switching uses standard optical fiber connectors. Mizukami et. al., supra, built a 200×200 automated optical fiber cross-connect system in 2005 using a fiber-handling robot in 2005, which is illustrated in FIG. 1. As illustrated in FIG. 1, the 200×200 cross-connect system 10 is communicatively connected to a PC 20 via a controller 30. The controller 30 provides instructions to the cross-connect system 10 for switching. Essentially half of the fiber I/O cords 60 in Mizukami et. al. are pre-connected to a panel with connectors arranged in a 2D array, while the other half are arranged and stored in a fiber storage cartridge 70 with fiber guiding feature and extra fiber pooling and a one-dimensional linear cord arrangement board. A fiber-handling robot 50 is used to mimic the patching of a telephone operator to pick a fiber jumper cord 80 from the storage cartridge 70 and insert the connector 90 into the destination port on the connector panel 40 to make a connection. With MU type of optical connectors, 200×200 non-blocking cross-connects with low insertion loss of 1 dB or less was achieved. To make a new connection without fiber entangling, the corresponding fiber jumper cord 80 is first disconnected from the connector panel 40 by the robot 50, rewound into the fiber storage cartridge 70 with its connector 90 rearranged on an arrangement board before the robot 50 picks it up again and insert it into a new destination port on the connector panel 40. Consequently, the switching time could be very long.

A. S. Kewitsch from Telescent Inc. later improved the connection reconfiguration control algorithm based on the Theory of Knots and Braids (see “Telescent G3 NTM.”, supra and Kewitsch, supra) to link a 2-D input array to a 1-D intermediate array, and demonstrated automated cross-connect with reconfigurability in a completely non-blocking fashion and scalable to large port count of 1000×1000. However, the switching time was not improved. On average it would take a few minutes to connect any input to an output port because of the complex control algorithm for minimizing the fiber entangling.

In this disclosure, a low-cost robotic fiber cross-connect system using off-the-shelf standard fiber connectors is provided. Specifically, an apparatus of fiber circuit switching with latching using stacked rotor plates and one moving robot is disclosed. Further, this disclosure provides an advantageous solution by utilizing fiber patch cords with standard connectors commonly used in the art, which further lowers the cost of the overall solution. To realize fiber cross-connect using fiber patch cords with off-the-shelf standard connectors without having to worry about fiber entanglement, a straightforward solution is to have the input and output fiber ports moving orthogonally in two separate planes. This disclosure utilizes a slightly modified implementation of such principle.

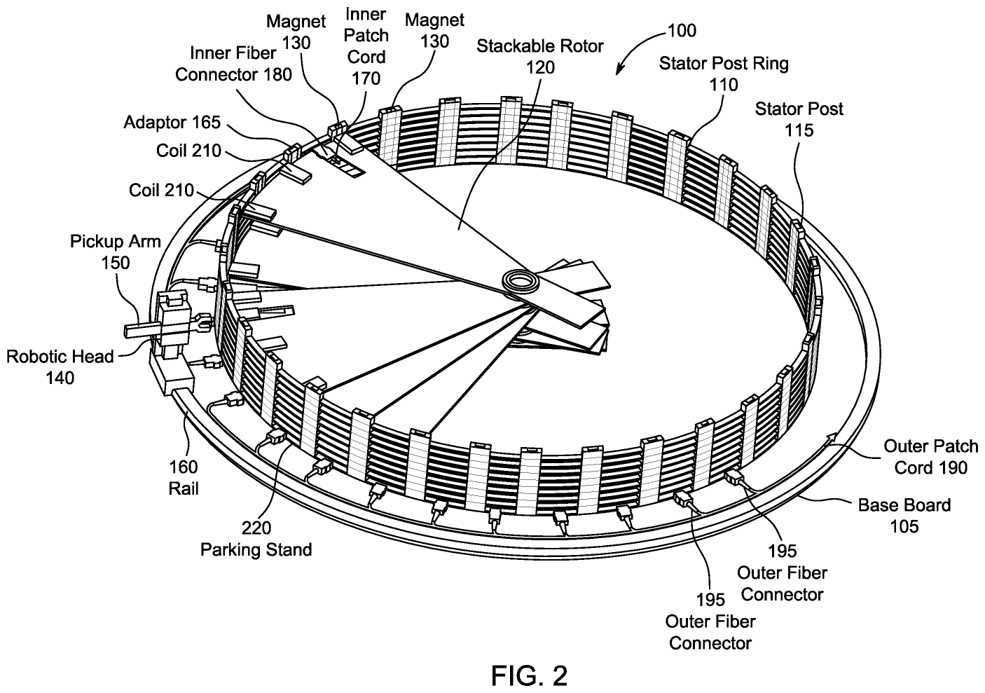

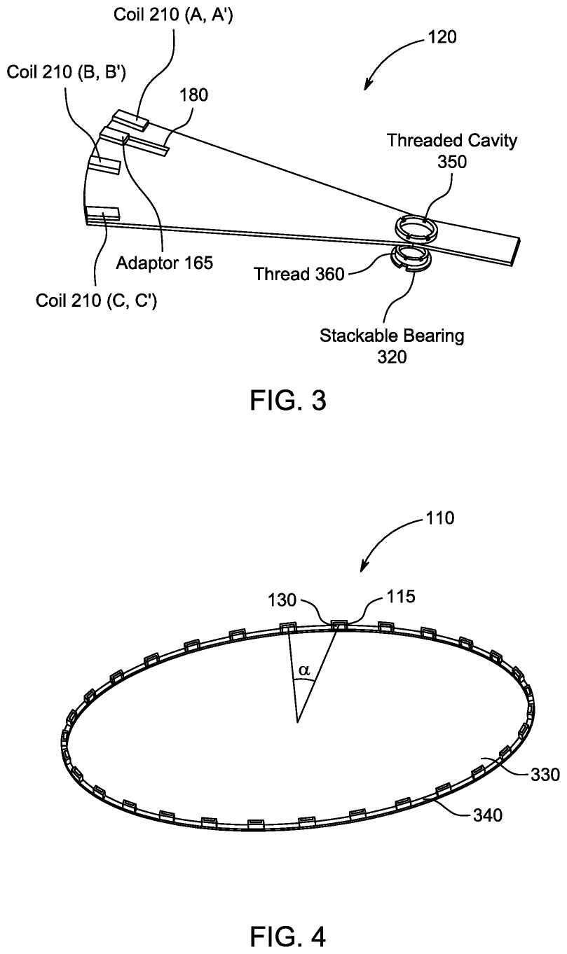

FIG. 2 illustrate the robotic fiber switching system 100 according to an embodiment of the present disclosure. Referring to FIG. 2, the robotic fiber switching system 100 (or interchangeably hereinafter “robotic switch” or “switch”) includes a circular shaped base board 105. On top of the base board 105, a plurality of fan-shaped stackable rotors 120 are stacked on top of each other and locate in the middle of the robotic switch 100. The stackable rotors are designed to be modular and stackable with each other, allowing for a number of rotors to be added, removed or replaced. Each stackable rotor 120 represents a layer of the robotic fiber switching system 100. As such, the number of the stackable rotors is also the number of the layers of the robotic fiber switching system 100.

The stackable rotor may freely and independently rotate in 360 degrees on the layer it is in with regard to a common axis located in the center of the switch. On the boundary of the circle that the stackable rotors may rotate in, a plurality of ring-shaped stackable stators 110 are concentrically stacked therein, each corresponding to a stackable rotor.

Along the circle of ring-shaped stackable stators 110, there are a plurality of stator posts 115 evenly distributed therein, which will be described in further detail below. According to an embodiment of the present disclosure, the stator posts 115 are periodically raised portions on the stackable stators. According to an embodiment of the present disclosure, each stator post 115 is configured to house a magnet 130. The spaces between neighboring stator posts 115 correspond where the fiber connectors may be latched on for switching. When multiple layers of stators are stacked together as illustrated in FIG. 2, each port can be identified by a 2-dimension notation using the slot number and the layer number. People skilled in the art understand that the total number of ports of switch 100 are customizable by selecting stackable stators with certain number of stator posts 115 and certain number layers of the stackable stators.

Outside of the stackable stators 110, the robotic switch 100 further includes a robotic head 140 that can freely move around a circular rail 160 located at the outmost edge of the base board 105. A pickup arm 150 is placed on top of and supported by the robotic head 140, which is configured to grab the connectors to latch to and unlatch from the ports of the switch 100. The switch 100 cross-connects by establishing connections between the inner patch cords 170 and the outer patch cords 190. The inner patch cords 170 are connected to inner fiber connectors 180 located on the stackable rotors. The outer patch cords 190 are connected to outer fiber connectors 195 located outside of the stackable stators, configured to be picked up by the pickup arm 150. According to an embodiment of the present disclosure, when establishing a connection at a port, the inner patch cords 170 and outer patch cords 190 are connected via an adaptor 165 located on the stackable rotors 120, which will be described in further detail below. According to the present disclosure, the inner fiber connectors 180 and the outer fiber connectors 195 can be selected from low-cost, off-the-counter connectors, which is advantageous to some cross-connect systems in the art.

The robotic switch 100 is configured to cross-connect any inner patch cord to any outer patch cord. The outer patch cords 190 are fixedly located with regard to the base board 105. In other words, the outer ports are fixed with regard to the base board 105. To establish a connection, the robotic switch 100 will locate the rotor at the right layer and cause the rotor to move to where the outer port is. When an outer fiber connector 195 is not connected to any inner fiber connectors 170, it is inserted into parking stands 220 not connected any inner fiber connectors. When a connection is to be established, the robotic arm 150 will insert, or latch, the outer fiber connectors 195 to the target layer above to establish a connection after the rotor already stepped the inner fiber connector into the port and ready to connect.

The illustration in FIG. 2 illustrates the hardware with respect to the switching of the robotic fiber switching system 100. The robotic fiber switching system 100 also includes other parts not illustrated therein. For example, the robotic switch may further include a cover to enclose all or part of the system illustrated in FIG. 1. Further, one or more controller that interfaces between the hardware and a computer in a manner similar to controller 30 of FIG. 1 is required. The controller takes instructions from and communicates with a computing unit, such as a PC, to coordinate the operation of the robotic fiber switching system 100. As described later, steps such as connecting to/disconnecting from between an inner patch cord 170 and an outer patch cord 190, stepping of the stackable rotors carrying the patch cord 170, automatically moving of the robotic head 140 and the pickup arm 150, and other steps performed by relevant parts are coordinated by the controller in conjunction with other computing units connected. People skilled in the art understand also those parts are not illustrated in FIG. 2, they may be included in the robotic switch disclosed herein.

FIG. 3 illustrates a single stackable rotor according to an embodiment of the present disclosure. Referring to FIG. 3, the stackable rotor 120 is a thin, fan-shaped planar plate with a bigger end and a smaller end. On the smaller end, there is a threaded cavity 350, which is configured be threadedly attached to a stackable bearing 320. The stackable rotor can freely rotate 360 degrees around the stackable bearing 320. The threads on the stackable bearings 320 restrict the movement of the stackable rotors in the vertical direction and prevent the rotors from moving into the space of rotors of other layers. The stackable bearings 320 stack on top of each other at the central axis of the switch 100, with the stackable rotors 120 attached therein, they form the multiple layers as illustrated in FIG. 2. People skilled in the art will appreciate that there may be alternative embodiments that facilitate the free and independent movements of the stackable rotors without the threaded cavity 350 or the stackable bearings 320. Or there may be one bearing for all layers of the rotors. These alternatives embodiments are within the scope and spirit of the present disclosure.

On the bigger end of the stackable rotor 120, the curved edge conforms to the curve of the circular stacked stators. Therefore, when the stackable rotor 120 rotates on the bearing 320, the curved edge keeps a constant and close distance to the stator slots. At the end of the curved edge, there is a coil set including three coils 210 mounted thereon. The three coils are separated with an equal angle separation θ from each other. According to an embodiment of the present disclosure, the coils are formed by forming conductive wires into loops and have two ends. The three coils 210 in the coil set are identified as 210 (A, A′), 210 (B, B′) and 210 (C, C′) respectively as illustrated in FIGS. 2 and 3. People skilled in the art understand that by providing certain electric currents to the coils, a magnet field can be developed that flows through the center of the coil. The magnetic field generated by the magnetically activated coil will interact with the magnets 130 in the stator posts 115 of the stackable stator 110. The currents of the coil and the orientation of the magnets are arranged to generate a force of attraction between them. The magnetic attraction causes the rotor 120 to move to the position of the nearest magnet 130 and stop there to allow for the outer fiber connector 195 to be latched on the desired inner fiber adaptor 165 to establish a connection between the inner patch cord 170 and the outer patch cord 190.

According to an embodiment of the present disclosure, a fiber connector adaptor 165 is mounted on the stackable rotor plate between coil 210 (A, A′) and 210 (B, B′). The adaptor 165 is configured to provide adaptation to the off-the-shelf optical fiber connector 180 of an inner patch cord 170. The inner connector 180 is pre-inserted into the adaptor 165. When the robotic switch 100 is in operation, the controller will identify the port of the connection. That is, the controller will identify the layer to which the inner patch cord 170 is connected to and the slot to which the outer patch cord 190 is parked. The stackable rotor of the identified layer will step towards the destination slot where the outer patch cord connector 195 is parked.

At the designation port, the adaptor 165 will stop at the midpoint of the slot between two neighboring stator posts, such that the connector 195 of the outer patch cord 190 can be robotically latched on the adaptor 165 and establish a connection. According to an embodiment, to facilitate the automatic connection, the adaptor 165 is located ⅜θ degrees away from coil 210 (A, A′), the selection of this angle will be explained in further details below. As illustrated in FIG. 2, when the stackable rotor 120 is set up, the connector 180 of the inner patch cord 170 is pre-inserted into the adaptor 165. To provide room for the connector 180 and its corresponding cord 170, there is a small cut-out on the rotor 120 right behind the adaptor 165 according to an embodiment of the present disclosure.

FIG. 4 is a detailed illustration of a single stackable stator 110 according to an embodiment of the present disclosure. Referring to FIG. 4, the single stator 110 has a number of identical stator posts 115 evenly distributed across the circle of the stator 110. Each stator post 115 houses a magnet 130 therein. The stator posts sit on a ring-shaped stator base 340, which connects all of stator posts 115 and place them on the same plane. If we denote the total number of the stator posts 115 on the stator 110 as m and the angle separation between the neighboring magnets 130 as α, then we will have α=360/m. The slot 330, i.e. space between the neighboring stator posts 115, allows the outer connectors 195 go in and latch the adaptor 165 on the rotor 120.

As illustrated in FIG. 2, the outer fiber connectors 195 on the parking stand 220 are evenly distributed on the base board 105. According to an embodiment, the outer fiber connectors 195 are located at the midpoint of the slots. As such, the outer fiber connectors have an angle separation of α/2 to their two neighboring stator posts 115 and an angle separation of a to their neighboring stator posts.

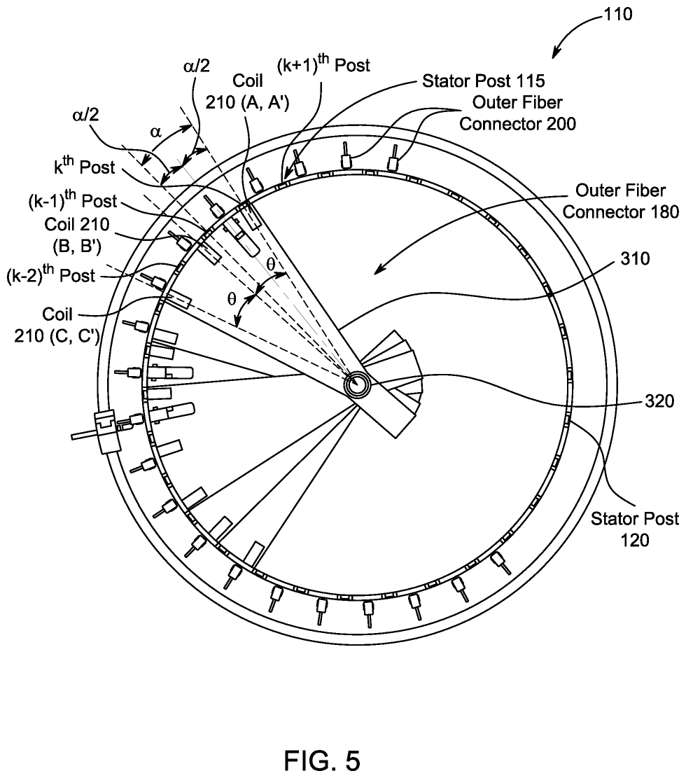

FIG. 5. is a top view of the robotic switch according to an embodiment of the present disclosure. In this embodiment, the angle separation θ among the coils 210 (A, A′) and 210 (B, B′), and 210 (C, C′) on the stackable rotors 120 is set to be 4/3 a, a being the angle separation between the neighboring stator posts as described above. The stepping movement of the stackable rotors is propelled by the magnetic attractions between the magnetically activated coils and the closest magnets 130 in the stator posts 115 around the stator base 340.

The coils in the coil set are magnetically activated in turn to drive the stackable rotor 120 to continuously step, or rotate, to the desired slot, where the outer fiber connector can be picked up and inserted to the connector adaptor 165 by the vertically moving pickup arm 150. To describe the process, we assume that the stackable rotor 120 of i^{th} layer that need to be stepped to the j^{th} slot is currently in the position where the first coil 210 (A, A′) is aligned with the magnet 130 at k^{th} stator post 115.

This position may result from the situation that the coil 210 (A, A′) was magnetically activated and the magnetic attraction between the 210 (A, A′) and the magnet 130 at the k^{th} stator post 115 aligned them. As illustrated in FIG. 5, due to the angle relation θ=4/3 a, when the coil 210 (A, A′) and the k^{th} stator post 115 are so aligned, coil 210 (B, B′) is ⅓ a away in angle from the (k−1)^{th} stator post 115 and coil 210 (C, C′) is ⅔ a away in angle from the (k−2)^{th} stator post 115. To further propel the movement of the i^{th} rotor 120, robotic switch 100 will magnetically deactivate coil 210 (A, A′) and activate coil 210 (B, B′). As described above, coil 210 (B, B′) is now in the close vicinity, i.e. ⅓ a angle separation, of the stator post (k−1)^{th} stator post 115, the attraction between the coil and the magnet will provide the force that causes the i^{th} rotor 120 to turn ⅓ a angularly and clockwise to align the coil 210 (B, B′) and the k−1^{th} stator post 115. After this movement, the coil 210 (C, C′) will be ⅓ a away in angle from the (k−2)^{th} stator post 115. Similarly, robotic switch 100 will then magnetically deactivate coil 210 (B, B′) and activate coil 210 (C, C′). As such, the magnetic attraction between coil 210 (C, C′) and the (k−2)^{th} stator post will further turn the i^{th} rotor by ⅓ a in angle. When the coil 210 (C,C′) is so aligned with the (k−2)^{th} stator post, the first coil 210 (A, A′) is now turned to the position that is ⅓ a away in angle from the (k+1)^{th} stator post 115. As such, robotic switch 100 may deactivate oil 210 (C, C′) and reactivate coil 210 (A,A′) and repeat the above process, the rotor 120 will continue to turn ⅓ a at a time and eventually reach the target stator post 115 on the stackable stators 110.

In the above example, the i^{th} stackable rotor 120 turns in the clockwise direction. By changing the magnetic activation sequence, i.e. from activating the coil sets in the order of (A, A′), (B, B′), (C, C′) and so on, to activating them in the order of (C, C′), (B, B′), (A,A′) and so on, the i^{th} rotor 120 will turn in the counter clockwise direction. As such, the robotic fiber switching system 100 may decide which direction is shorter to reach in terms of a circle and turn the stackable rotor in that direction accordingly. According to an embodiment, by choosing the angles θ and a satisfying θ=4/3 a, the rotor 120 evenly turns ⅓ a as the coils sequentially activates. The even movement in every step enhances the smoothness and durability of the switch 100. In addition, by placing the adaptor 165 ⅜θ degrees away from coil 210 (A, A′), which equals to ½ a degrees, when the 210 (A, A′) finally reaches and aligns with a stator post 115, the adaptor 165 will be located at the midpoint between the two neighboring stator posts 115 of the destination slot, ready for connection.

People skilled in the art understand that the robotic switch 100 may be optimized in choosing coils 210 and the magnets 130 that provide strong attraction within a working distance, i.e. ⅓ a in the example, to effectively and quickly step the rotor but with quickly attenuated attraction for longer distance, such as near ⅓ a to reduce attractions of the coil to other magnets 130. People skilled in the art also understand that numerous changes may be made to the switch 100. For example, different numbers of coils, such as 2, 4, or other numbers may be used or different angle correlations between a and θ may be adopted. For another example, the adaptor 165 may be placed at other positions with regard to the coil set together with other modifications to the embodiment. Those alternatives will require corresponding but apparent changes to the design details to the present embodiment. It is understood that those alternatives, whether described herein or not, are within the scope of the present disclosure.

According to the embodiment described above, the stator base 340 is a ring-shaped structure upon which the stator posts 115 are disposed. The stackable stators 110 are stacked by putting the stator bases 340 on top of each other with the stator posts 115 of the same ports aligned across the layers. As such, the stator bases 340 are stackable regarding each other. In another embodiment, the stackable stator base 340 connecting the neighboring posts is eliminated, in which case the stator posts 115 with magnets 130 of multiple layers of the same slot are directly stacked on top of each other. In this case, it is preferred that the stator posts are designed in LEGO®-like structure in the sense that one stator post 115 can be securely inserted into another stator post. This alternative embodiment provides the same slot space for the inner patch cords 170 and outer patch cords 190 to connect at the port and can be easily adapted to the overall all design of the robotic fiber switching system 100 described above.

In order to make a connection, the outer cord connector 195 is latched to the adaptor 165 after the adaptor has been stepped into position. As described above in connection with FIG. 2, the outer fiber connectors 195 are placed at the outside of the stackable stators 110 and in the midpoint of the slots 330. Slots 330 are fixedly located on the base board 105. The outer fiber connectors 195 are disposed of along the rail 160 of the robotic head to be connected to or disconnected from the ports of the slots. When in operation, the robotic head 140 moves on the rail 160 and carries the pickup arm 150 on the top. As illustrated in FIG. 2, the outer patch cords 170 are placed in parking stand 220 if not connected to any inner patch cords 170. When an outer patch cord 190 needs to be connected to certain port, the robotic head will move to the location of the slot where the port is in. The pickup arm is configured to move up and down, i.e. vertically, and in and out, i.e. horizontally. as illustrated by the arrows on FIG. 2. The vertical movement allows the pickup arm 150 to reach all ports from the multiple layers stacked at the same slot. The horizontal movement will allow the pickup arm 150 to latch or unlatch the connector 195, either with regard to the adaptor 165 or the parking stand 220. According to an embodiment of the present disclosure, the pickup arm 150 uses a clamp or hand-like structure that can open and close to hold the connectors 195 as illustrated in FIG. 2. The pickup arm 150 can work with connectors and adaptors that requires a latching, providing robust connections resistant to external forces such as earthquake. In this disclosure, by having the outer fiber cords 190 at fixed locations around the robotic switch 100 and providing a parking slot for the outer cord connectors 195, it reduces cord entanglement for the outer cords 190.

Although the present disclosure describes or illustrates the connecting the inner and outer patch cords of the robotic switch operations as occurring in a particular order, the present disclosure contemplates any suitable operations occurring in any suitable order. Moreover, the present disclosure contemplates any suitable operations being repeated one or more times in any suitable order.

The present disclosure encompasses all changes, substitutions, variations, alterations, and modifications to the embodiments herein that people having ordinary skill in the art would comprehend. Similarly, where appropriate, the appended claims encompass all changes, substitutions, variations, alterations, and modifications to the embodiments herein that people having ordinary skill in the art would comprehend.

None of the description in this disclosure should be read as implying that any particular element, step of function shall be an essential element that must be included in the claims scope. The scope of the patented subject matter is defined only by the claims as follows.

What is claimed is:

1. A robotic fiber switching system, comprising:
n layers of stacked stators each comprising m slots among m stator posts, providing n×m ports;
n layers of stacked rotors configured to turn inside of the stacked stators, each layer corresponding to a layer of the stacked stators and comprising a first connector;
m second connectors disposed of outside of the stacked stators, each corresponding to a slot of the stator;
a robotic head configured to move on a rail surrounding the n stacked stators, wherein a robotic arm located on a top of the robotic head is configured to connect the first connector and the second connector at a port of the robotic fiber switching system and wherein m and n are natural numbers.

2. The robotic fiber switching system of claim 1, wherein the robotic arm is configured to move in a horizontal direction and a vertical direction.

3. The robotic fiber switching system of claim 2, wherein the robotic arm further comprising a clamp configured to open and close in such a manner that the robotic arm may latch and unlatch the second connectors with respect to adaptors to which the first connectors were pre-inserted.

4. The robotic fiber switching system of claim 1, further comprising m parking stands, wherein the second connectors are inserted in the parking stands when they are not connected to any of the first connectors.

5. The robotic fiber switching system of claim 1, further comprising:
n sets of coils disposed of on an edge of each of the stacked rotors, wherein the set of coils are configured to be magnetically activated;
n×m magnets, each disposed in a stator post,
wherein when a coil in a coil set on a stacked rotor is magnetically activated, a magnetic attraction generated between said coil and a nearby magnet will cause said stacked rotor to turn an angle aligning the stacked rotor and the nearby magnet.

6. The robotic fiber switching system of claim 5, wherein all coils in the coil set are configured to sequentially magnetically activated and continuously turn the stacked rotor in a direction.

7. The robotic fiber switching system of claim 6, wherein there are three coils in each coil set, separated by equal angles θ, wherein θ=4/3 a and wherein α=360/m.

8. The robotic fiber switching system of claim 7, wherein each of the stacked rotors further comprising an adaptor disposed ⅜θ degrees away from a right-most coil.

9. The robotic fiber switching system of claim 1, wherein each of the n layers of stacked stators further comprising a ring-shaped stackable stator base, upon which the m stator posts are evenly disposed of.

10. The robotic fiber switching system of claim 1, wherein the stator posts are stacked on each other.

11. The robotic fiber switching system of claim 1, wherein the first connectors and second connectors are off-the-shelf connectors.

12. The robotic fiber switching system of claim 1, further comprising a controller, wherein the controller is configured to provide instructions to the robotic fiber switching system to automatically connect and disconnect the first connectors and second connectors.

13. A method of a robotic fiber switching system, comprising:
determining to establish a connection between an i^{th} first connector of n first connectors to a j^{th} second connector of m second connectors, wherein each of the n first connectors is disposed of on a corresponding layer of stacked rotors and each of the m second connectors are disposed of in a corresponding slot outside of n layers of stacked stators;
turning a stacked rotor in the i^{th} layer to the j^{th} slot of the stacked stator;
moving a robotic head on a rail to the j^{th} slot; and
connecting the j^{th} second connector to the i^{th} first connector,
wherein m and n are natural numbers.

14. The method of claim 13, wherein the turning comprising:
magnetically activating a set of coils disposed of at an edge of the stacked rotor of the i^{th} layer, wherein the magnetically activated coils are sequentially attracted to a nearby magnet disposed in a stator post, causing the stacked rotor in the i^{th} layer to turn to the j^{th} slot.

15. The method of claim 14, wherein the stackable rotor comprising three coils with equal angle separations of θ; wherein θ=4/3 a and wherein α=360/m.

16. The method of claim 15, wherein each of the stacked rotors further comprising an adaptor disposed ⅜θ degrees away from a right-most coil.

17. The method of claim 13, wherein the connecting comprising:
moving a robotic arm downward vertically to a level of a parking stand where the j^{th} second connector is located;
moving the robotic arm forward horizontally;
grabbing the j^{th} second connector in a clamp of the robotic arm;
moving the robotic arm backward horizontally;
moving the robotic arm upward vertically to the i^{th} layer; and
latching the j^{th} second connector to an adaptor at the i^{th} layer to which the i^{th} first connector is inserted.

18. The method of claim 14, wherein the stacked rotor at the i^{th} first connector moves in a circle with regard to a stacked bearing of the i^{th} layer.

19. The method of claim 13, wherein the turning and moving are undertaken simultaneously.

20. A fiber switching system, comprising:
n layers of stackable rotors, each stackable rotor comprising a first connector connected with a first patch cord;
n layers of stackable stator, each stackable stator comprising:
a second connector connected to a second patch cord; and
m slots; and
a robotic arm configured to access the m slots by moving on a rail horizontally and to the n layers vertically,
wherein the robotic arm latches the second connector to the first connector via an adaptor to establish connection between the first patch cords and the second patch cords.
